(19) United States
(12) Patent Application Publication
(10) Pub. No.: US 2003/0013997 A1
(43) Pub. Date: Jan. 16, 2003

(54) VENOUS PUMP

(76) Inventor: SESHADRI RAJU, JACKSON, MS (US)

Correspondence Address: JONES, WALKER, WAECHTER, POITEVENT, CARRERE, & DENEGRE, L.L.P., 5TH FLOOR, FOUR UNITED PLAZA, 8555 UNITED PLAZA BOULEVARD, BATON ROUGE, LA, 70809, US

(21) Appl. No.: 09/454,985

(22) Filed: Dec. 3, 1999

(51) Int. Cl. A61H 15/00

(52) U.S. Cl. 601/152

(57) ABSTRACT

The invention is a venous pump used to promote circulation in an extremity. It comprises an inflatable chamber, a compression cell, and tubes to carry a fluid between them. The compression cell is designed to be placed underneath the foot so that walking produces a cyclical compression. The inflatable chamber is designed to be secured about a limb. When weight is placed on the foot, fluid is forced into the inflatable chamber which expands and applies pressure to the limb. When weight is removed, fluid is forced back into the compression cell, removing the pressure from the limb.

### BACKGROUND OF INVENTION

This invention relates to therapeutic devices, particularly to devices for applying compressive pressures against a limb.

In a normal limb, superficial veins located just under the skin empty into the deep venous system. This transfer is promoted by muscle contractions that continuously empty the deep venous system, creating a pressure differential. In some persons, however, the emptying of the superficial veins may be impeded by a variety of factors. These include: 1) reduced compliance of the superficial veins due to varicosity formation, post-thrombotic changes, or other abnormalities, 2) a prevalence of higher than normal pressure in the deep system due to higher than normal blood flow, venous valve reflux, or post-thrombotic changes involving the deep system veins, and 3) poor muscle contraction due to a variety of neurologic and muscular pathologies.

Poor emptying of the superficial veins into the deep system may lead to aching pain, tiredness, swelling, stasis dermatitis, and even skin ulceration. Compression of a limb in a cyclical manner aids the emptying of these veins and can reduce or eliminate the associated symptoms.

Many devices known in the art accomplish this cyclical compression. U.S. Pat. No. 5,186,163, for example, consists of several inflatable chambers from the foot to the top of the leg. The sequential inflation of the chambers aids in the transfer of blood in leg. The design is complex, however, requiring a powered pressure source, a controller, and several solenoid valves in addition to tubing and inflatable chambers.

U.S. Pat. No. 4,372,297 discloses a similar device with a less complex design. Through the use of a simplified pressure source and fewer inflatable chambers, the weight and cost of the apparatus come down considerably. It uses a bellows type pump attached to the underside of a shoe that is actuated as weight is put onto the foot. This simple design is superior in many ways than the previous, but it is awkward and creates a serious impediment to normal motion.

U.S. Pat. No. 4,805,601 uses a pump that is contained within a shoe structure. When weight is placed on the foot, air is forced into an adjoining chamber that expands and applies pressure to the ankle area. This arrangement allows for more normal walking than does the exterior bellows configuration. However, because there is no remote chamber, its design only enables the rehabilitation of an injured ankle or foot. Also, the bulkiness of the design makes it unsuitable for running or other strenuous exercise.

### ADVANTAGES AND OBJECTS OF THE INVENTION

It is an object of the present invention to provide a therapeutic device that converts walking energy into a pressure source and applies that pressure cyclically to a limb.

Another object of this invention is that it be comfortable for use during normal walking or running in contrast to the prior art.

It is also an object of this invention to be usable in conjunction with a normal piece of footwear.

Still another object of this invention, and an advantage over the prior art, is to provide the foregoing functionality in a simple and inexpensive design.

### SUMMARY OF INVENTION

The present invention is a therapeutic device comprising an inflatable chamber and a compression cell. During use, the inflatable chamber is secured to a portion of the anatomy, usually a portion of the leg, such that it applies pressure to the surface of the skin during inflation. The compression cell is placed under the foot within a shoe and communicates with the chamber through tubes. The cell is actuated by the weight of the user during walking or running such that a cyclical pressure cycle is created. Use of the invention improves circulation and decreases injury recovery time.

### BRIEF DESCRIPTION OF THE DRAWINGS

FIG. 1 illustrates an embodiment of the present invention positioned on a lower leg in a manner consistent with its use.

FIG. 2 illustrates a cross-sectional view of the inflatable bladder.

### DETAILED DESCRIPTION OF THE INVENTION

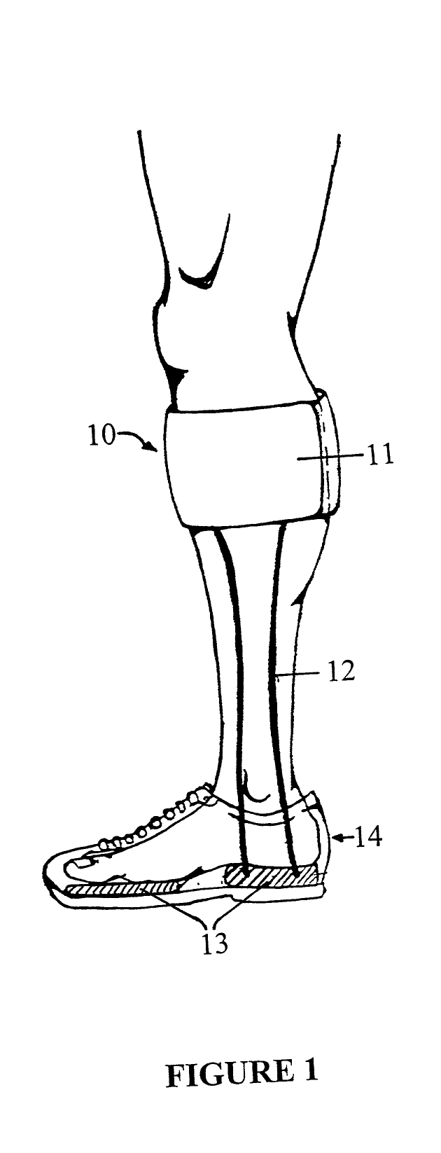

FIG. 1 illustrates one manner of positioning the invention. Therapeutic device 10 comprises inflatable bladder 11, shown secured about the calf area, which is designed to expand inwardly as it is inflated. Tubes 12 extend from inflatable bladder 11 to compressible cells 13. Although two tubes are shown in the figure, any number may be used. Compressible cells 13 act together and may in fact be formed of only a single cell structure. Also, it is not necessary to have a cell structure adapted to be positioned under both the balls of the foot and the heel.

In one embodiment of the invention, cell(s) 13 are inserted into a piece of footwear. The cells are designed such that they may be used with any type of athletic or walking shoe. They are shaped such that when they are inserted into the piece of footwear they will be held in position without slippage by the structure of the shoe. In another embodiment the invention comprises shoe 14, into which compressible cell(s) 13 are integrated. In yet another, a fastening means is included so that footwear such as sandals or slippers, which do not have good support structures, may be used without fear of slippage.

Together, inflatable bladder 11, tube(s) 12, and compressible cell(s) 13 contain an amount of fluid sufficient to fully inflate bladder 11 when cell(s) 13 are fully compressed. The working fluid may be a gas (such as ambient air) or a liquid.

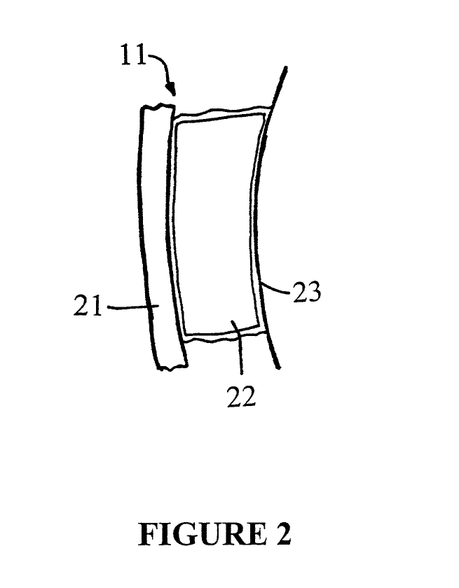

FIG. 2 illustrates one possible construction of inflatable bladder 11. Fluid chamber 22, having thin, elastic walls, lies between the surface of the skin 23 and an inflexible outer membrane 21 during use. This design prevents the inflatable bladder from expanding outwardly during inflation. Tubes 12 (shown in FIG. 1) are connected to chamber 22 such that they may carry fluid between chamber 22 and cells 13.

To improve circulation in a calf, the following procedure may be used. Secure inflatable bladder 11 about the calf region. Put shoe 14 on the foot. If compression cells 13 are not integrated into shoe 14, the user should insert cells 13 into a piece of footwear, secure them using the attaching means if necessary, and the footwear should then be placed on the foot. If another device is required for the other leg, the same process should be used. The user is now ready for normal exercise involving walking or running. When weight is placed on compression cells 13, they expel their fluid which travels along tubes 12 and empties into fluid chamber 22. This creates relatively high pressure inside fluid chamber 22, which expands, applying pressure to the surface of the skin. When weight is removed from compression cells 13, the resulting pressure differential causes most of the fluid to be expelled from fluid chamber 22 back into compression cells 13.

What is claimed is:

1. A therapeutic device comprising:
an inflatable chamber, attachable to a portion of the human anatomy; and
at least one compression cell, remote from and fluidly communicating with said inflatable chamber.

2. The therapeutic device of claim 1 wherein said compression cell comprises a chamber adapted to be positioned under the ball of the foot.

3. The therapeutic device of claim 1 wherein said compression cell comprises a chamber adapted to be positioned under the heel of the foot.

4. The therapeutic device of claim 1 wherein said compression cell comprises a chamber adapted to be positioned substantially under the entire foot.

5. The therapeutic device of claim 1 wherein said compression cell conforms to, and is held in place by, the structure of a piece of footwear.

6. The therapeutic device of claim 1 further comprising an attachment means for securing said cells to a piece of footwear.

7. The therapeutic device of claim 1 wherein said inflatable chamber comprises a layer of inflexible material such that when said device is in use most of the expansion of said chamber is directed inwardly.

8. A therapeutic device comprising:
footwear,
an inflatable chamber, attachable to a portion of the human anatomy; and
at least one compression cell, remote from and fluidly communicating with said inflatable chamber, said compression cell(s) being integral with said footwear.

9. The therapeutic device of claim 8 wherein said compression cell comprises a chamber positioned to be under the ball of the foot.

10. The therapeutic device of claim 8 wherein said compression cell comprises a chamber positioned to be under the entire foot.

11. The therapeutic device of claim 8 wherein said inflatable chamber comprises a layer of inflexible material such that when said device is in use most of the expansion of said chamber is directed inwardly.
